(19) United States
(12) Patent Application Publication
(10) Pub. No.: US 2023/0398584 A1
(43) Pub. Date: Dec. 14, 2023

(54) SLIDING CHIP SWEEPER SYSTEM

(71) Applicant: Team Industrial Services, Inc., Sugar Land, TX (US)

(72) Inventors: David Benjamin ALDREN, Sugar Land, TX (US); Brian Michael GRESH, Sugar Land, TX (US); Oliver EVANS, Cumbria (GB)

(21) Appl. No.: 18/036,332

(22) PCT Filed: Dec. 14, 2021
(86) PCT No.: PCT/US2021/063413

§ 371 Date: May 10, 2023

Related U.S. Application Data
(60) Provisional application No. 63/126,208, filed on Dec. 16, 2020.

(51) Int. Cl. B08B 9/043

(52) U.S. Cl. CPC B08B 9/0436

(57) ABSTRACT

A technique which facilitates cleaning of an interior of a pipe via access through a lateral hole in the pipe. The technique utilizes a control bar head coupled with a sweeper system which may be inserted into the pipe through the lateral hole. The sweeper system may comprise a plurality of shiftable sweeper heads which generally align for insertion through the lateral hole and then transition along the interior of the pipe to effectively sweep particles along the interior of the pipe. The sweeper system effectively clears an area of the interior of the pipe to facilitate a more effective seal with a subsequently inserted pipe isolation device.

### CROSS-REFERENCE TO RELATED APPLICATION

The present document is based on and claims priority to U.S. Provisional Application Ser. No. 63/126,208, filed Dec. 16, 2020, which is incorporated herein by reference in its entirety.

### FIELD OF DISCLOSURE

In general, the disclosure describes a pipe cleaning system which may be inserted through a lateral hole in a pipe. The pipe cleaning system utilizes a control bar head coupled with a sweeper system which may be inserted into the pipe through the lateral hole to sweep particles that may have collected at the bottom of the pipe during cutting of the lateral hole.

### BACKGROUND OF DISCLOSURE

When performing pipeline maintenance or servicing, such as during hot tapping procedures, it is necessary to tap through a side wall of the pipe to enable isolation of a section of the pipe via a pipe isolation device. However, the process of tapping through the side wall of the pipe can create metal chips, i.e. particles, which fall to the lower side of the pipe. Such particles can interfere with operation of the pipe isolation device. For example, the particles can affect the ability of the pipe isolation device to create suitable seals between the pipe isolation device and the surrounding interior wall of the pipe.

What is needed is a pipe cleaning device which can easily be inserted through a tapped hole in a sidewall of the pipe and which can then be operated to sweep the chips/particles away from the seal area of a subsequently inserted pipe isolation device.

### SUMMARY

This summary is provided to introduce a selection of concepts that are further described below in the detailed description. However, many modifications are possible without materially departing from the teachings of this disclosure. Accordingly, such modifications are intended to be included within the scope of this disclosure as defined in the claims. This summary is not intended to identify key or essential features of the claimed subject matter, nor is it intended to be used as an aid in limiting the scope of the claimed subject matter.

According to an embodiment, a system and methodology facilitate cleaning of an interior of a pipe via access through a lateral hole in the pipe. The technique utilizes a control bar head coupled with a sweeper system which may be inserted into the pipe through the lateral hole. The sweeper system may comprise a plurality of shiftable sweeper heads which generally align for insertion through the lateral hole and then transition along the interior of the pipe to effectively sweep particles along the interior of the pipe. The sweeper system effectively clears an area of the interior of the pipe to facilitate an improved seal with a subsequently inserted pipe isolation device.

### BRIEF DESCRIPTION OF THE FIGURES

Certain embodiments of the disclosure will hereafter be described with reference to the accompanying drawings, wherein like reference numerals denote like elements. It is emphasized that, in accordance with standard practice in the industry, various features are not drawn to scale. In fact, the dimensions of various features may be arbitrarily increased or reduced for clarity of discussion. It should be understood, however, that the accompanying figures illustrate the various implementations described herein and are not meant to limit the scope of various technologies described herein, and:

FIG. 1 is an illustration of an example of a pipe cleaning device having a sweeper system in general axial alignment with a control bar head for insertion through a lateral hole in a pipe in accordance with embodiments of the present disclosure;

FIG. 2 is an illustration of the pipe cleaning device illustrated in FIG. 1 but with the sweeper system transitioned laterally along the interior of the pipe in accordance with embodiments of the present disclosure;

FIG. 3 is a cross-sectional view of an example of the pipe cleaning device configured in the axially extended position in accordance with embodiments of the present disclosure; and

FIG. 4 is an end in view of an example of the pipe cleaning device located within a pipe in accordance with embodiments of the present disclosure.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements.

The present disclosure generally relates to a system and methodology for cleaning an interior of a pipe via access through a lateral hole in the pipe. The technique provides a dependable approach for moving particles resulting from cutting the lateral hole in the pipe. By moving the particles farther along the pipe and away from the location beneath the lateral hole, an improved sealing area is provided for a subsequently installed pipe isolation device.

According to an embodiment, the technique utilizes a control bar head coupled with a sweeper system which may be inserted into the pipe through the lateral hole. The sweeper system may comprise a plurality of shiftable sweeper heads which generally align axially for insertion through the lateral hole and then transition laterally along the interior of the pipe to sweep particles along the interior of the pipe. The sweeper system effectively clears an area of the interior of the pipe to facilitate an improved seal with a subsequently inserted pipe isolation device.

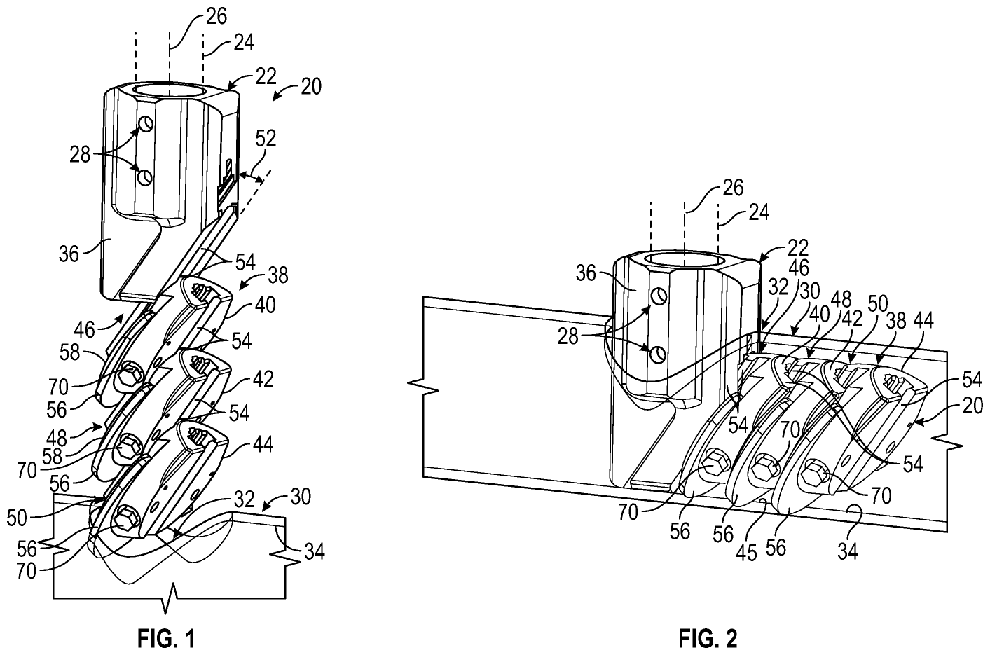

Referring generally to FIGS. 1-2, an embodiment of a pipe cleaning system 20 is illustrated as having a pipe cleaning device 22 coupled with a control bar 24 which is linearly movable along an axis 26. By way of example, the control bar 24 may be coupled with pipe cleaning device 22 via a coupling mechanism 28, e.g. threaded fasteners. The control bar 24 may be part of an overall actuator used to control the insertion and transition of pipe cleaning device 22 within a pipe 30. Linear movement of the control bar 24 moves the pipe cleaning device 22 into pipe 30 through a lateral hole or opening 32 in the pipe 30 (see FIG. 1) and induces lateral transitioning along an interior 34 of pipe 30 (see FIG. 2). Linear movement of the control bar 24 in the opposite direction enables withdrawal of the pipe cleaning device 22 from pipe 30 via lateral hole 32. Control bar 24 may be coupled with or formed as part of a hydraulic actuator or other suitable actuator of the type used to position pipe isolation devices.

In the embodiment illustrated, the pipe cleaning device 22 comprises a control bar head 36 coupled with control bar 24 and with a sweeper system 38 configured to sweep chips/particles along the interior 34 of pipe 30 as the pipe cleaning device 22 is inserted through lateral hole 32. By way of example, the sweeper system 30 may comprise a plurality of sweeper heads, such as a first sweeper head 40, a second sweeper head 42, and a third sweeper head 44 which are slidably engaged with each other. The first sweeper head 40 also is slidably engaged with control bar head 36. The sliding engagement facilitates sliding transition between an insertion/withdrawal configuration in which sweeper heads 40, 42, 44 are generally aligned along axis 26 and an internal laterally transitioned configuration in which the sweeping heads 42, 44 are shifted laterally along the interior of pipe 30. As the sweeper system 38 is moved through lateral hole 32 and into engagement with a lower interior region of the pipe 30, the sweeper heads 40, 42, 44 are forced to transition from the generally axially aligned configuration to the laterally transitioned configuration. This transition between axial and lateral configurations is used to sweep particles along the interior of pipe 30 and away from a sealing area 45 utilized by a subsequently inserted pipe isolation device.

As illustrated, the pipe cleaning device 22 comprises a first sliding engagement mechanism 46 which provides a slidable engagement connection between the control bar head 36 and the first sweeper head 40. Similarly, the illustrated pipe cleaning device 22 comprises a second sliding engagement mechanism 48 which provides a slidable engagement connection between the first sweeper head 40 and the second sweeper head 42. A third sliding engagement mechanism 50 may be used to provide a slidable engagement connection between the second sweeper head 42 and the third sweeper head 44.

In this example, the sweeper heads 40, 42, 44 each generally have a disk shape and the sliding engagement mechanisms 46, 48, 50 are arranged to enable sliding at an angle 52 relative to axis 26. The angle 52 is selected to enable general alignment of control bar head 36, first sweeper head 40, second sweeper head 42, and third sweeper head 44 along axis 26 during insertion and withdrawal of pipe cleaning device 22 through opening 32. By way of example, each sliding engagement mechanism 46, 48, 50 may comprise interlocking rails 54 or other suitable interlocking slides which accommodate the angular sliding of first sweeper head 40 relative to control bar head 36, of second sweeper head 42 relative to first sweeper head 40, and of third sweeper head 44 relative to second sweeper head 42 (see FIG. 1). It should be noted that different numbers of sweeper heads may be employed depending on the parameters of a given operation and on the overall length of the internal pipe region to be swept.

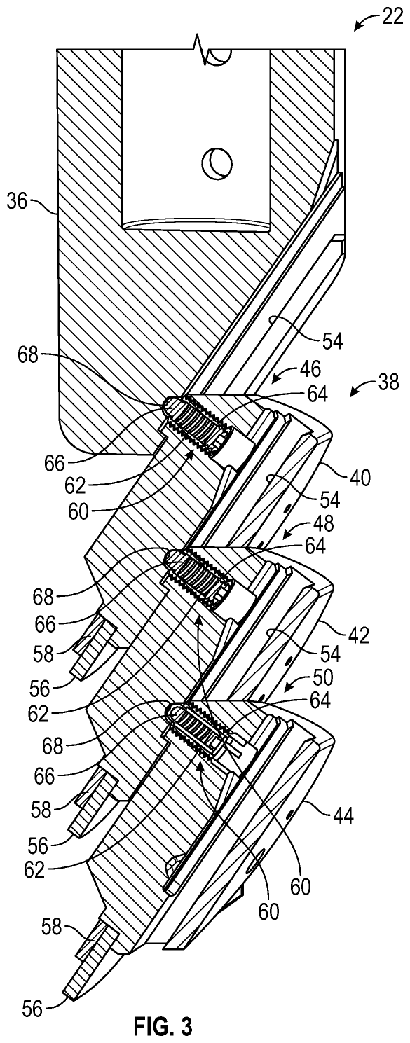

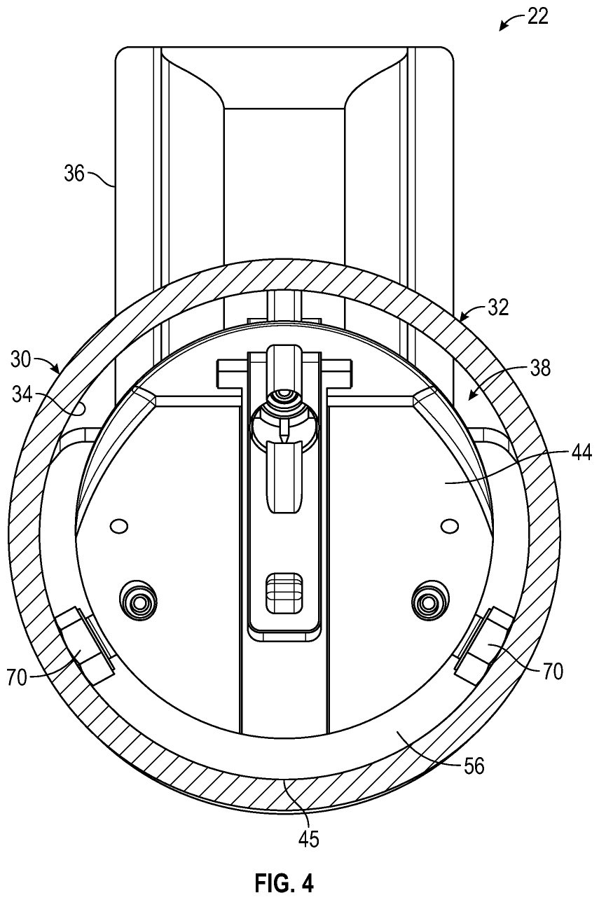

With additional reference to FIGS. 3 and 4, the sweeper system 38 also may comprise a plurality of sweepers 56 attached to corresponding sweeper heads 40, 42, 44. By way of example, the sweepers 56 may be secured along a portion of the circumference of each sweeper head 40, 42, 44. As illustrated, the sweepers 56 may be secured so as to extend below each of the corresponding sweeper heads 40, 42, 44 when the sweeper system 38 is in the laterally transitioned, extended configuration illustrated in FIGS. 2 and 4. In other words, the sweepers 56 are oriented to slide along the lower interior of pipe 30 so as to sweep away interfering particles from sealing area 45 as the sweeper system 38 transitions from the generally axially aligned configuration to the laterally transitioned configuration. In some embodiments, the sweepers 56 are formed from a suitable flexible material, e.g. a rubber material or other suitable material.

Additionally, the sweepers 56 may be made in different sizes and from different materials relative to each other. For example, the lead sweeper 56 coupled with third sweeper head 44 may be constructed from a relatively softer material than the other sweepers 56 and with a slightly larger diameter to create more interference with the interior surface of pipe 30. This construction helps initially move a greater portion of the particles, e.g. shavings, away from sealing area 45 as the sweeper system 38 is inserted and transitioned to the laterally extended configuration within pipe 30.

The sweepers 56 may be secured to their corresponding sweeper heads 40, 42, 44 via a variety of mechanisms. In some embodiments, each sweeper 56 is squeezed against its corresponding sweeper heads 40, 42, 44 by a retainer plate 58. Each retainer plate 58 may be secured to the corresponding sweeper heads 40, 42, 44 via screws or other appropriate fasteners able to ensure the corresponding sweeper 56 is adequately secured therebetween.

To facilitate insertion of pipe cleaning device 22 through lateral hole 32, the sweeper heads 40, 42, 44 may initially be releasably held in the generally axial configuration via retention mechanisms 60. As illustrated in FIG. 3, one embodiment of retention mechanisms 60 comprises spring plungers 62. Each spring plunger 62 may be positioned in a passage 64 of the corresponding sweeper head and oriented to bias a plunger end 66 into a corresponding recess 68 of the next adjacent sweeper head (or adjacent control bar head 36). It should be noted the spring plungers 62 may be staged to ensure sequential actuation in which the third sweeper head 44 actuates (slides) first, the second sweeper head 42 actuates second, and the first sweeper head 40 actuates third during insertion. The staging to ensure sequential actuation may be accomplished by various mechanisms including using different springs on the different spring plungers 62 and/or differing angles on the corresponding recesses 68. Additionally, other locking mechanisms, e.g. different shear pins or pushrod actuated latches, may be used to ensure the sweeper heads 40, 42, 44 actuate with the desired timing/sequence.

Depending on the parameters of a given environment and application, the pipe cleaning device 22 may comprise various other components and features. By way of example, abutments 70 may be located along the sweeper system 38 to ensure sweepers 56 are properly positioned (see FIG. 4). In the illustrated embodiment, the abutments 70 are constructed as brass screws threaded into and extending from lower portions of each sweeper head 40, 42, 44. The brass screws 70 or other abutments may be secured in place via setscrews or other securing mechanisms. The abutments 70 extend sufficiently to properly position the sweeper heads and the sweepers 56 as the pipe cleaning device 22 performs its pipe cleaning action, i.e. as the pipe cleaning device 22 is transitioned from the insertion position illustrated in FIG. 1 to its fully laterally extended position illustrated in FIG. 2. It should be noted the abutments 70 may be constructed in various forms and numbers to accomplish the desired positioning and thus the desired sweeping action.

Depending on the parameters of a given pipe cleaning operation, however, the configuration and use of overall pipe cleaning system 20 may be adjusted. For example, various numbers of sweeper heads may be used to provide the desired sweeping action while transitioning the pipe cleaning system 20 between operational positions. Additionally, the number, type, and arrangement of sweepers 56 can be selected according to the type of particulates to be moved and on the environment in which pipe cleaning system 20 is employed. The sliding engagement mechanisms also may be constructed in various configurations to provide the desired transitioning in environments in which the pipe cleaning system 20 is to be used for clearing the sealing region.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. A system for cleaning an interior of a pipe via access through a lateral hole in the pipe, the system comprising:
a control bar head having a coupling feature for coupling with a control bar; and
a sweeper system coupled to the control bar head, the sweeper system having:
a first sweeper head slidably coupled with the control bar head to enable transition between a generally axial configuration for insertion through the lateral hole and a laterally transitioned configuration within the pipe;
a second sweeper head slidably coupled with the first sweeper head to enable transition between the generally axial configuration for insertion through the lateral hole and the laterally transitioned configuration within the pipe; and
a plurality of flexible sweepers, at least one flexible sweeper coupled with each of the first sweeper head and the second sweeper head in an orientation for sweeping particles along the interior of the pipe as the first sweeper head and the second sweeper head are inserted through the lateral hole and transitioned between the generally axial configuration and the laterally transitioned configuration.

2. The system as recited in claim 1, wherein the sweeper system further comprises a third sweeper head slidably coupled with the second sweeper head to enable transition between the generally axial configuration for insertion through the lateral hole and the laterally transitioned configuration within the pipe.

3. The system as recited in claim 2, further comprising an additional flexible sweeper coupled with the third sweeper head.

4. The system as recited in claim 1, wherein each flexible sweeper is secured in place in the sweeper system via a retainer plate.

5. The system as recited in claim 2, wherein the first, second and third sweeper heads are initially held in the generally axial configuration via retention mechanisms.

6. The system as recited in claim 5, wherein the retention mechanisms comprise spring plungers.

7. The system as recited in claim 1, wherein the flexible sweepers of the plurality of flexible sweepers are oriented to slide along a bottom of the interior of the pipe during transition between the generally axial configuration and the laterally transitioned configuration.

8. The system as recited in claim 1, wherein the sweeper system further comprises abutments located to ensure the flexible sweepers of the plurality of flexible sweepers are properly positioned to facilitate sweeping of the particles from a sealing area within the pipe.

9. The system as recited in claim 8, wherein the abutments comprise brass screws coupled to the first and second sweeper heads.

10. A system for cleaning an interior of a pipe via access through a lateral hole in the pipe, the system comprising:
a control bar head having a coupling feature for coupling with a control bar; and
a sweeper system coupled to the control bar head, the sweeper system having:
a sweeper head slidably coupled with the control bar head to enable transition between a generally axial configuration for insertion through the lateral hole and a laterally transitioned configuration within the pipe; and
a flexible sweeper coupled with the sweeper head in an orientation for sweeping particles along the interior of the pipe as the sweeper head is inserted through the lateral hole and transitioned between the generally axial configuration and the laterally transitioned configuration.

11. The system as recited in claim 10, further comprising a second sweeper head slidably coupled with the sweeper head to enable transition between the generally axial configuration for insertion through the lateral hole and the laterally transitioned configuration within the pipe; and a second flexible sweeper coupled with the second sweeper head in an orientation for sweeping particles along the interior of the pipe as the second sweeper head and the sweeper head are inserted through the lateral hole and transitioned between the generally axial configuration and the laterally transitioned configuration.

12. The system as recited in claim 11, further comprising a third sweeper head slidably coupled with the second sweeper head to enable transition between the generally axial configuration for insertion through the lateral hole and the laterally transitioned configuration within the pipe; and a third flexible sweeper coupled with the third sweeper head in an orientation for sweeping particles along the interior of the pipe as the third sweeper head, the second sweeper head, and the sweeper head are inserted through the lateral hole and transitioned between the generally axial configuration and the laterally transitioned configuration.

13. The system as recited in claim 12, wherein the flexible sweeper, second flexible sweeper, and third flexible sweeper are secured in place in the sweeper system via corresponding retainer plates.

14. The system as recited in claim 12, wherein the sweeper head, second sweeper head, and third sweeper head are initially held in the generally axial configuration via retention mechanisms.

15. The system as recited in claim 14, wherein the retention mechanisms comprise spring plungers.

16. The system as recited in claim 12, wherein the sweeper system further comprises abutments connected to the sweeper head, the second sweeper head, and the third sweeper head to ensure the flexible sweeper, the second flexible sweeper, and the third flexible sweeper are properly positioned to facilitate sweeping of particles from a sealing area in the pipe.

17. A method, comprising:
providing a sweeper system with a plurality of sweeper heads slidably coupled to each other along a suitable angle to enable transition between a generally axial configuration and a laterally transitioned configuration;
attaching a flexible sweeper to each sweeper head of the plurality of sweeper heads;
moving the sweeper system through a lateral hole in a pipe until the sweeper system engages a lower region of the pipe; and
sweeping the lower region with the flexible sweepers by continuing movement of the sweeper system into the pipe until the plurality of sweeper heads transition from the generally axial configuration to the laterally transitioned configuration.

18. The method as recited in claim 17, wherein providing comprises providing the sweeper system with at least two sweeper heads.

19. The method as recited in claim 17, wherein providing comprises providing the sweeper system with at least three sweeper heads.

20. The method as recited in claim 17, further comprising using retention mechanisms to initially hold the sweeper system in the generally axial configuration.
